(19) United States
(12) Patent Application Publication
(10) Pub. No.: US 2010/0192721 A1
(43) Pub. Date: Aug. 5, 2010

(54) Pull-Pull Cable Assembly Having a Self-Adjusting Cable Tensioning Assembly

(75) Inventors: Gerald M. Goupil, JR., N. Tonawanda, NY (US); William F. Rausch, Middleport, NY (US); Mark W. Stevenson, Appleton, NY (US); Daniel McCutcheon, Frederick, MD (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/697,570

(22) Filed: Feb. 1, 2010

Related U.S. Application Data
(60) Provisional application No. 61/206,363, filed on Jan. 30, 2009.

(51) Int. Cl. F16C 1/22; F16C 1/14

(52) U.S. Cl. 74/501.5 R

(57) ABSTRACT

The improved pull-pull cable assembly includes a self-adjusting tensioning assembly for taking up any additional cable length gained relative to the sheathing length when the pull-pull pulley assembly is bent or looped. The self-adjusting tensioning assembly is contained within the interior compartment of one of the two pulleys and includes a biasing member simultaneously urging the first and second ends of the cable across the center of the pulley, thereby pulling or taking-up any relative increase in cable length into the interior compartment to maintain proper cable tension.

### CROSS REFERENCE TO RELATED APPLICATIONS

This application claims the benefit of U.S. Provisional Patent Application Ser. No. 61/206,363 for an IMPROVED PULL-PULL CABLE, filed on Jan. 30, 2009, which is hereby incorporated by reference in its entirety. This claim is made under 35 U.S.C. §119(e); 37 C.F.R. §1.78; and 65 Fed. Reg. 50093.

### TECHNICAL FIELD OF INVENTION

The invention relates to a pull-pull cable assembly; more specifically, to a pull-pull cable assembly having a self-adjusting cable tensioning assembly.

### BACKGROUND OF INVENTION

As an alternative to more costly electronic controllers, various types of mechanical linkages have been used in motor vehicles for operatively controlling various remotely located accessories, such as vent doors within a heating, venting, and air conditioning (HVAC) module from a control level or knob conveniently mounted on the dash board or control panel within the passenger compartment. One type of mechanical linkages that is widely used is a pull-pull cable assembly, which is a mechanical actuation device that conveys input rotary motion from a control knob via cables to output rotary motion in an actuation pulley to drive a valve, cam, or gear.

Shown in FIG. 1 is an exemplary conventional pull-pull cable assembly 10 that includes an elongated flexible cable 11 having a first end 12 and second end 14 attached to a first pulley 16 and an intermediate portion 18 therebetween secured to a second pulley 20. In the conventional pull-pull cable assembly 10 shown in FIG. 1, the first pulley 16 is adapted to actuate a remotely located accessory (not shown) and the second pulley 20 is rotationally fixed to a rotary control knob (not shown). The flexible cable 11 is contained within a flexible sheathing 22, in which the inner diameter of the sheathing 22 is larger than the outer diameter of the flexible cable 11 in order for the flexible cable 11 to slide relatively freely with respect to the sheathing 22.

The conventional pull-pull cable assembly 10 may be routed through a labyrinth of twists and turns from the passenger compartment to the remotely located accessory. The tortuous routing of the pull-pull cable assembly 10 may cause the flexible cable 11 and the sheathing 22 to bend, loop, and/or deform into substantially acute angles abutting against the inner wall of the sheathing 22. This sheathing 22, having an aperture of a cross section substantially larger than the cross section of the flexible cable 11, allows the flexible cable 11 to float within such aperture. Therefore when the flexible cable 11 and the sheathing 22 are bent, looped, and/or deformed into substantially acute angles the flexible cable 11 abuts against the inner wall of the sheathing 22. When the pull-pull cable assembly is looped, the cable 11 flexes toward the inner bend of the loop within the sheathing 22. This is like a runner running on a track with the aperture through the interior of the sheathing being the track, the flexible cable 11 travels along the inside of the track, a shorter distance through the interior of sheathing between the first pulley 16 and the second pulley 20 as compared to the outside of the track or outer most interior surface of the aperture within the sheathing 22, which results in the flexible cable 11 to extend beyond the sheathing as compared to when the pull-pull cable assembly 10 is in a straight orientation as shown in FIG. 1. Furthermore, the flexible cable 11 lengthens and shortens relative to the sheathing 22 with fluctuations in ambient temperature.

The increase in length of the flexible cable 11 relative to the length of the sheathing 22 results in dragging and bunching of the flexible cable 11 against the inner wall of the sheathing 22. The flexible cable 11 dragging against the inner wall of the sheathing increases the amount of input torque required to operate the controlled device. The higher input torque requirement may cause consumer dissatisfaction due to the additional effort required to rotate the control knob to overcome the friction between the flexible cable 11 and the inner wall of the sheathing 22. If the flexible cable 11 is not taut and bunches within the sheathing 22, it may cause backlash in the control knob resulting in an unrefined or a lesser quality tactile feel to the operator and may cause the device being controlled not be actuated to the desired position.

To accommodate for the increase in the length of the flexible cable 11 relative to the sheathing 22, the pull-pull cable assembly 10 shown in FIG. 1 provides a torsion spring 15 clipped onto the bearing surface of the first pulley, in which the torsion spring 15 includes two extended ends secured to the first and second ends 12, 14 of the flexible cable 11, respectively. A drawback to the configuration of the torsion spring 15 being clipped onto the bearing surface is that the torsion spring 15 increases rotational drag on the first pulley 16 and may chuck from side to side as the direction of rotation of the first pulley is changed. Another drawback is that the uptake of the flexible cable 11 is limited by the distance of the outer circumference of the first pulley 16. With the greater the distance between the first and second ends 12, 14 the less angular distance the first pulley 16 can rotate. Still another drawback is the inability to securely attach the first and second ends 12, 14 of the flexible cable 11 onto the extended ends of the torsion spring 15.

There is a need for a pull-pull pulley assembly that includes a cable tensioning assembly that actively adjusts the flexible cable to the proper length and maintains proper cable tension. There is a further need for the cable tensioning assembly to accommodate additional length of flexible cable beyond what is capable of the conventional pull-pull pulley shown in FIG. 1. There is still a further need for a cable tensioning assembly that provides a quality tactile feel to the operator. There is still a further need for a self-adjusting cable tensioning assembly that is cost efficient, robust, and simple to manufacture.

### SUMMARY OF THE INVENTION

The pull-pull cable assembly according to the present invention includes a first pulley, a remotely positioned second pulley, a flexible cable interconnecting the pulleys, a sheathing enclosing the portion of the flexible cable located between the two pulleys, and a self-adjusting cable tensioning assembly. The self-adjusting cable tensioning assembly having a biasing mean is provided in the interior compartment of one of the pulleys. The cable tensioning assembly maintains the proper cable length and tension to ensure relatively free sliding movement of the flexible cable within the sheathing in order to provide proper operation and a refined quality tactile feel.

One of the pulleys includes a perimeter wall having two end portions that turn inward toward the center of the pulley to define the interior compartment and a channel leading into the interior compartment. The channel provides a passageway through which the first and second cable ends of the flexible cable are threaded into the interior compartment. The first and second ends of the flexible cable are wrapped around the groove of the first pulley from opposing directions and enter the interior compartment via the channel defined by the perimeter wall.

Within the interior compartment the first and second ends are bounded together by a crimp or a swage. A collar having a cross-section slightly larger than the cross-sectional area of the swage is provided to engage the biasing mean. The biasing mean may include a flat spring plate, a tension coiled spring, or a compression coiled spring. The collar may have features for co-axially aligning the swage with the length of the spring.

An advantage of the present invention is that the biasing mean provides uniform tension on both cables. Another advantage is that the placement of the biasing mean in the interior compartment of the first pulley provides a compact package volume. Yet another advantage to the biasing mean being within the interior compartment is that it provides greater cable length take-up as compared to conventional pull-pull cable assemblies. Still, another advantage to the coiled spring being within the interior compartment is that it provides increased contact area between pulley and cable.

Further features and advantages of the invention will appear more clearly on a reading of the following detailed description of an embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a plan view of a conventional pull-pull cable assembly having a torsion spring.

FIG. 2 is a plan view of a pull-pull cable assembly having a self-adjusting cable tensioning assembly according to the present invention.

FIG. 3 is a cross-sectional view of the pull-pull cable assembly taken along line 3-3 of FIG. 2.

FIG. 4 is a perspective view of a pulley containing the self-adjusting cable tensioning assembly.

FIG. 5 is a partial cut-away view of FIG. 4 showing the routing of the first and second ends of the flexible cable about the pulley.

FIG. 6 is a detail view of section 6 of FIG. 5 showing the self-adjusting cable tensioning assembly.

FIGS. 7 A & B show the first and second ends of the cable having alternative swage and collar attachments.

### DETAILED DESCRIPTION OF INVENTION

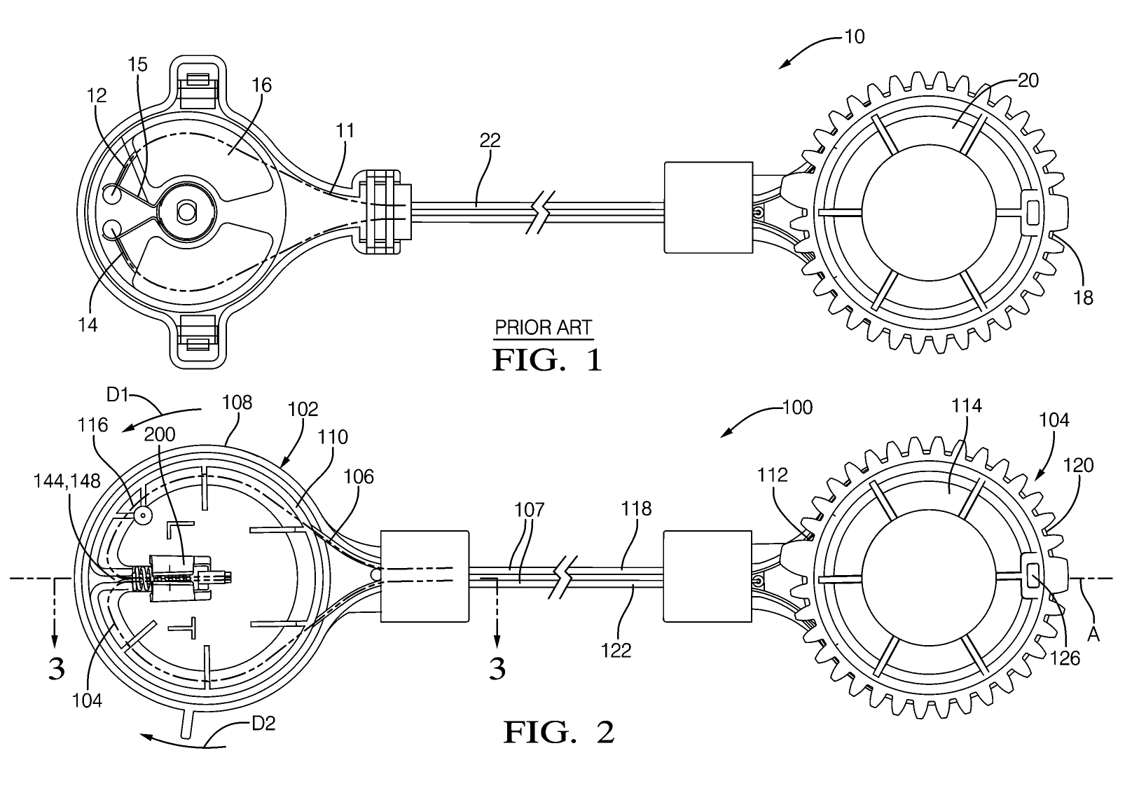

In accordance with a preferred embodiment of this invention, shown in FIGS. 2 through 7, is a pull-pull pulley assembly 100 for using a rotary control knob to actuate a remotely located accessory, such as a vent door within a HVAC module (not shown). The pull-pull cable assembly 100 includes a self-adjusting tensioning assembly 200 contained within one of its two pulleys 110, 114 for taking up any additional cable length gained relative to the sheathing length and associated cable slack when the pull-pull pulley assembly 100 is provided with at least one bend or loop.

Shown in FIG. 2 is a plan view of the pull-pull cable assembly 100 of the present invention. The cable assembly 100 includes a first pulley assembly 102, a remotely positioned second pulley assembly 104, a flexible cable 106 interconnecting the pulley assemblies 102, 104, and a sheathing 107 enclosing the portion of the flexible cable 106 located between the two pulley assemblies 102, 104. For descriptive purposes, the flexible cable 106 is shown extending along a longitudinal axis A. The first pulley assembly 102 is engaged to a control knob (not shown) preferably located on the dashboard or control panel within the passenger compartment of a motor vehicle and the second pulley assembly 104 is adapted to operate a remotely positioned motor vehicle accessory (not shown) such as a vent door within a HVAC module. A cable tensioning assembly 200 is provided in one of the pulley assemblies 102, 104 to maintain proper cable length and tension to ensure relatively free sliding movement of the flexible cable 106 within the sheathing 107 and to provide a refined quality tactile feel such as that of a precise 1:1 turn/actuation ratio and low torque operational effort found on more expensive electronic potentiometer controllers. For exemplary purposes, the cable tensioning assembly 200 is provided within pulley assembly 102, which is the control pulley that is rotationally engaged to a control knob.

The first pulley assembly 102 includes a first pulley housing 108 containing a first pulley 110. The second pulley assembly 104 includes a second pulley housing 112 containing a second pulley 114. Rotationally interconnecting the first pulley 110 and second pulley is the flexible cable 106. The flexible cable 106 includes a first cable end 116 attached to the first pulley 110, a first cable portion 118 extending from the first pulley 110 to the second pulley 114, an intermediate cable portion 120 rotationally secured to the second pulley 114, a second cable portion 122 extending from the second pulley 114 back to the first pulley 110, and a second cable end 124 attached to the first pulley 110. To be more exact, the first and second cable ends 116, 124 are attached to the cable tensioning assembly 200 contained within the first pulley 110, the detail description of which will be provided below. The first and second cable portions 118, 122 are slidably contained with the sheathing 107.

With regard to the second pulley assembly 104, a pocket 126 or recess is molded within the groove of the second pulley 114 to accept a swage attached to the intermediate portion 120 of the cable. This location for the swage is to maintain continuity in the cable's path and thus eliminating the stresses placed on the cable due to the abrupt change in the cable's path. The pocket may be tapered to minimize the swage from sliding back and forth as the pulley changes direction of rotation thus placing tension on one side of the cable versus the other. This pocket may also contain small features like ribs that crush when the swage is assembled into the pocket to also minimize the swage from sliding back and forth. This swage is located at the intermediate cable portion 120. The second pulley 114 is customized to engage the remote accessory to be controlled and may include a gear assembly adapted for the specific application.

When a rotational moment is induced within one of the pulleys 110, 114 the flexible cable 106 transmits the rotational force to induce a corresponding rotation moment in the other one of the pulleys 110, 114. For exemplary purposes, the first pulley assembly 102 is engaged to a control knob (not shown); therefore, the first pulley 110 is the control pulley and the second pulley 114 is the actuation pulley. The first cable portion 118 will be in tension upon rotation of the first pulley 110 in a first direction D1. Conversely, the second cable portion 122 will be in tension upon rotation of the first pulley 110 in a second direction D2.

Fundamentally, a minimum clearance is required between the inner diameter of the sheathing 107 and the outer diameter of the flexible cable 11 in order for the flexible cable 11 to have sufficient clearance to slide freely relative to the sheathing 107. When the pull-pull cable assembly 100 is in a linear orientation as shown in FIG. 2, the first and second cable portions 118, 122 are co-axially aligned with their respective sheathing 107 and the lengths of the first and second cable portions 118, 122 are substantially the same as that of the length of their respective sheathing 107. When the pull-pull cable assembly 100 is routed through varies twists and turns from the dashboard to the remotely located accessory, the turning and looping of the pull-pull cable assembly 100 causes the flexible cable 106 to bend and/or deform into substantially acute angles, thereby causing the flexible cable 106 to abut and rub against the inner diameter of the sheathing 107. The excessive contact of the flexible cable 106 against the interior wall of the sheathing 107 results in increase friction and inhibits the relatively free reciprocal sliding movement of the flexible cable 106 with respect to the sheathing 107. Furthermore, as the cable is turned into a loop, the cable 106 shifts from the center of the sheathing toward the inner wall of the sheathing closer to the center of the loop much like a runner moving from the center lane to the inside lane of a track. The flexible cable 106 travels less distance as compared to the sheathing 107, resulting in an increase in cable length relative to the sheathing between the two pulley assemblies 102, 104 and resulting in increased cable slack. The increase in cable slack may be reduced or eliminated by utilizing a biasing member such as a preloaded spring to take up the additional slack on the flexible cable 106.

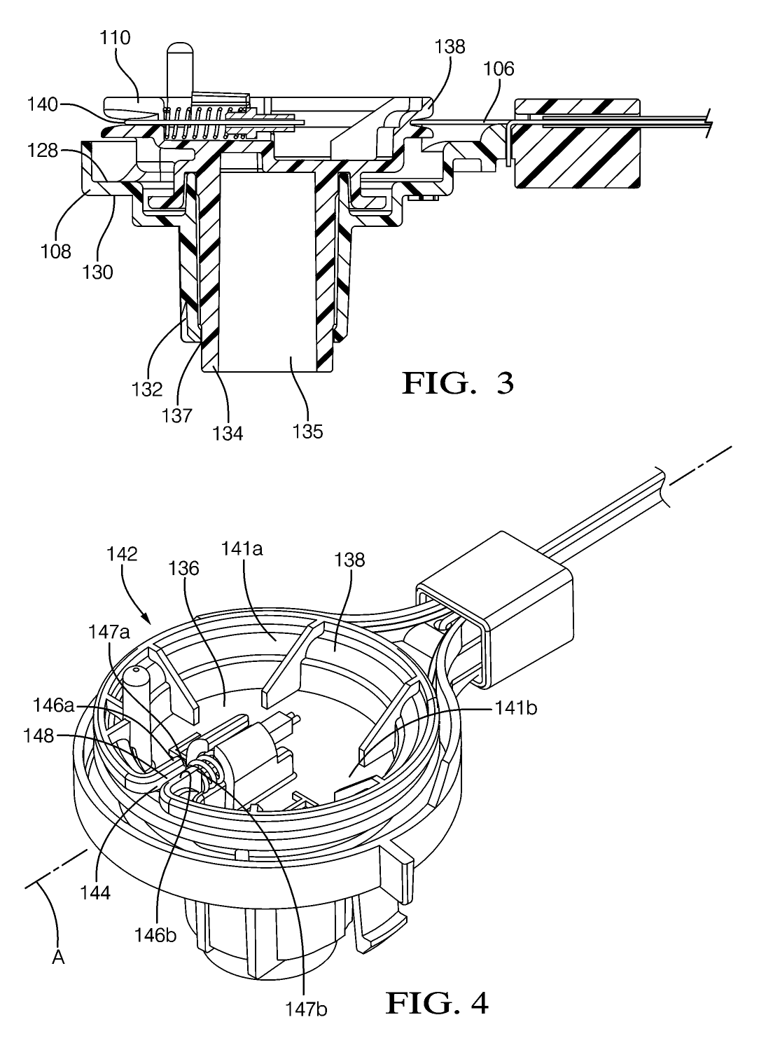

Shown in FIGS. 3 through 6, the first and second ends 116, 124 of the flexible cable 106 are attached to a biasing mean contained within the first pulley assembly 102 to reduce or eliminate cable slack for enhanced performance and increased quality tactile feel to the operator. Shown in FIG. 3 is a cross-sectional view of the first pulley assembly 102 along line 3-3 of FIG. 2. The first pulley assembly 102 includes a first pulley housing 108 having a first surface 128 and a second surface 130 opposite that of the first surface. Extending from the second surface 130 is a hollow substantially cylindrical column 132 having a bearing surface 137 adapted to be inserted through an opening in a control unit or in the dashboard within the passenger compartment of a motor vehicle. The first surface 128 includes a plurality of tabs and at least one snap tab to cooperate with a plurality of corresponding apertures in the first pulley 110 to engage and enable the first pulley 110 to freely rotate both in a clockwise and counter clockwise direction with respect to the pulley housing 108. The pulley housing 108 may also include rotational stops to prevent the first pulley 110 from over-travel in either direction of rotation.

The first pulley 110 includes a column stem 134 that extends through the bearing surface 137 of the cylindrical column 132 of the housing 108. The column stem 134 of the first pulley 110 defines a predetermined shaped cavity 135 which is complementary to the shape of the shaft of a rotary control knob. Shown in FIG. 4, the first pulley 110 includes a substantially disk shaped base 136 having a perimeter wall 138 extending perpendicularly relative to the disk shaped base 136 in a direction away from the column stem 134. The exterior surface of the perimeter wall 138 defines a circumferential groove 140 in which the cable 106 is guided and seated. The interior surface 141a of the wall together with the interior surface 141b of the first pulley 110 defines an interior compartment 142.

Shown in FIGS. 4-6, the perimeter wall 138 defines a passageway 144 that is substantially axially aligned with the first and second cable portion 118, 122 when the first pulley 16 is oriented in a neutral position as shown and the pull-pull cable assembly 100 is positioned along the longitudinal axis-A. The first and second cable ends 116, 124 of the flexible cable 106 are wrapped around the first pulley from opposing directions and threaded into the interior compartment 142 via the passageway 144. The first and second cable ends 116, 124 are engaged to a cable tensioning assembly 200 which maintains proper cable length and tension.

Shown in FIG. 4 is perspective view of an embodiment of the invention where the perimeter wall 138 includes two wall end portions 146a, 146b having wall terminus 147a, 147b that turn inward toward the center of the first pulley 110 to define a channel 148 leading into the interior compartment 142. The channel 148 provides the passageway 144 where the first and second cable ends 116, 124 are threaded into the interior compartment 142. Disposed within the interior compartment 142 along the longitudinal axis A is the cable tensioning assembly 200.

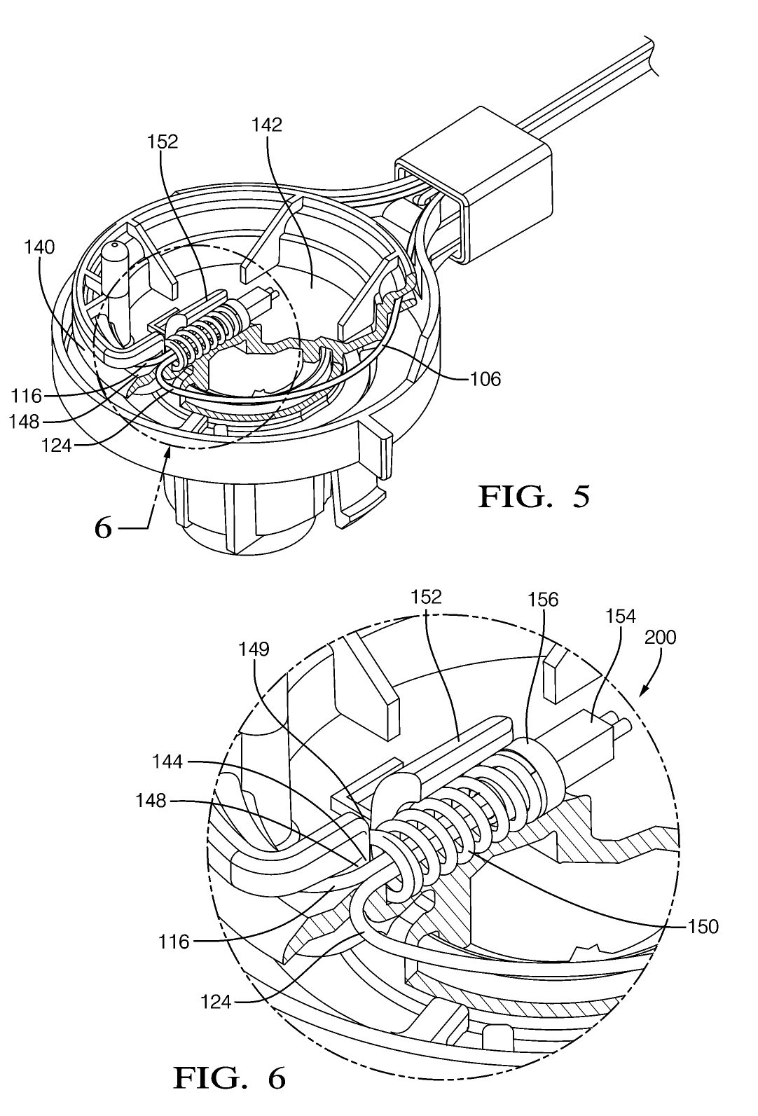

Shown in FIGS. 5 and 6 is a partially cut-away view of the first pulley assembly 102 shown in FIG. 4 detailing the tensioning assembly 200. The first and second cable portions 118, 122 extending along the longitudinal axis A is wrapped around the groove 140 of the first pulley 110 from opposing directions and enters the interior compartment 142 via the channel 148 defined by the perimeter wall 138. Within the interior compartment 142, the first and second cable ends 116, 124 are adjacently parallel to each other and bounded together by a crimp or a swage 154. A collar 156 having a cross-section slightly larger than the cross-sectional area of the swage is provided to abut against one end of a biasing mean 150.

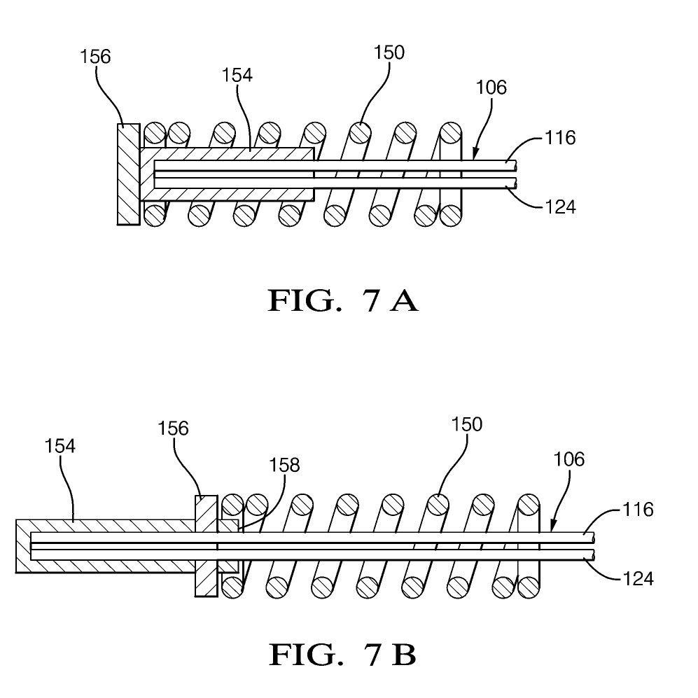

In the embodiment shown, positioned between the wall terminus 147a, 147b and the collar 156 is a coiled spring 150 under compression. The collar 156 may include a centering member 158 for co-axially aligning the swage 154 with the coiled spring 150. In FIG. 7, the swage 154 is shown internal to the spring 150, in which the swage 154 has a predetermine length to abut a portion of the wall terminus 147a, 147b to limit the compression travel of the spring 150. In FIG. 7 B, the swage 154 is shown external to the spring 150 and includes a centering member 158 that extends internal to the spring 150 to co-axially align the swage 154 within the coiled spring 150. The coiled spring 150 exerts a longitudinal force against the collar 156 and wall ends 147a, 147b in the longitudinal direction, thereby elongating and extending the flexible cable 106 within the interior compartment 142 of the first pulley 110 to take-up excess cable length and provides the proper cable tension. The coiled spring 150 fits over both the first and second cable ends 114, 124 to provide uniform tension on both cables. Also, the placement of the coiled spring 150 in the interior compartment 142 of the first pulley 110 provides a compact package volume and reduces the potential that a foreign object could damage the tensioning assembly 200. Coiled spring retainers 152 extending longitudinally from the interior surface 141 of the first pulley maintain the proper positioning of the coiled spring 150.

The biasing member presented above is a coiled spring 150 operating under compression and is presented for exemplary purpose only and it's not meant to be limiting. An alternative embodiment of the biasing member may be a compression or tension spring having a constant pitch, conical, barrel, hourglass, or variable pitch. For these options, excluding constant pitch, these types of springs would offer varying degrees of spring rate which may be required in situations where sudden surges in load exist and/or for taking up cable slack without drastically affecting torque required to actuate the pull-pull cable assembly 100. Yet, another alternative embodiment of the biasing member may be that of a flexible spring plate (not shown), which can be manufactured from a metallic material of a desired thickness that yields a spring rate to maintain the proper (predetermined) tension on the cables.

The spring 150 could be installed with a preload while the pull-pull cable assembly 100 is in a straight longitudinal orientation so that as the pull-pull cable assembly 100 is looped, the spring 150 would take up the slack in the cable. This predetermined amount would be based on the relationship between inner diameter of the sheathing relative to the cable outer diameter and the bearing clearances that exists between the parts that forms the pulley assembly and the overall length of the flexible cable and sheathing. The spring assembly would as a result produce a cable assembly with nearly zero backlash or hysteresis.

The pull-pull assembly of the present invention is susceptible to modifications, variations and change for use with other applications. While this invention has been described in terms of the preferred embodiments thereof, it is not intended to be so limited, but rather only to the extent set forth in the claims that follow.

Having described the invention, it is claimed:

1. A pull-pull cable assembly for remotely actuating an accessory, comprising:
a first pulley having a interior surface and a wall circumscribing said interior surface defining an interior compartment, wherein said wall further defines a cable passageway;
a second pulley remotely positioned from said first pulley;
a flexible cable rotationally interconnecting said first pulley and said second pulley, wherein said flexible cable includes a first end and a second end threaded through said passageway into said interior compartment of said first pulley;
a cable tensioning assembly having a biasing member disposed in said interior compartment of said first pulley, wherein said biasing member is engaged to said first and second ends of said cable urging said flexible cable into said interior compartment, thereby removing slack in said cable.

2. The pull-pull cable assembly of claim 1, wherein biasing member is a flexible spring plate.

3. The pull-pull cable assembly of claim 1, wherein said biasing member is a tension coiled spring pulling said first and second end across center of pulley.

4. The pull-pull cable assembly of claim 1, wherein said biasing member is a compression coiled spring pushing said first and second end across center of pulley.

5. The pull-pull cable assembly of claim 4, wherein said compression coiled spring includes a spring first end abutting a portion of said wall surrounding said passageway and a spring second end opposite that of said spring first end, wherein said first and second ends of said cable are engaged to said spring second end.

6. The pull-pull cable assembly of claim 5, wherein the first and second ends of cable are bounded together by a swage, wherein said swage includes a collar abutting said compression spring second end.

7. The pull-pull cable assembly of claim 6, where said swage includes a centering member positioned within coils of said compression coil spring.

8. The pull-pull cable assembly of claim 7, wherein said interior surface includes a spring clip engaging and maintaining said compression coiled spring in a predetermined orientation.

9. The pull-pull cable assembly of claim 8, wherein said perimeter wall includes two end portions turning inward toward center of said first pulley defining a channel leading into said interior compartment, and wherein said spring first end abuts said two end portions.

10. The pull-pull cable assembly of claim 9, wherein said compression coiled spring is axially aligned with said channel.

11. The pull-pull cable assembly of claim 8, wherein said first pulley is a controlled pulley and said second pulley is an accessory pulley.

12. The pull-pull cable assembly of claim 8 wherein said coil spring includes a variable pitch.

13. A pull-pull cable assembly for remotely actuating an accessory, comprising:
a first pulley having a interior surface and a wall circumscribing said interior surface defining an interior compartment, wherein said wall includes two wall end portions turning in toward interior surface to define a channel;
a second pulley remotely positioned from said first pulley;
an flexible cable encompassing said first and second pulley, wherein said flexible cable includes a first end and a second end threaded through said channel into said interior compartment of first pulley,
a cable tensioning assembly disposed in said interior compartment and urging said first and second cable ends into said interior compartment, thereby removing slack in said cable.

14. The pull-pull cable assembly of claim 13, wherein said cable tensioning assembly includes a compression coiled spring having a spring first end abutting said wall end portions and a spring second end opposite that of said spring first end engaged to said first and second ends of said flexible cable.

15. The pull-pull cable assembly of claim 14, wherein the first and second ends of cable are bounded together by a swage, wherein said swage includes a collar abutting said compression spring second end.

16. The pull-pull cable assembly of claim 15, wherein said interior surface includes a spring clip engaging and maintaining said compression coiled spring oriented across center of said first pulley.

17. The pull-pull cable assembly of claim 16, where said swage includes a centering member positioned within coils of said compression coil spring.

18. A pull-pull cable assembly for remotely actuating an accessory, comprising:
a first pulley having a interior surface and a wall circumscribing said interior surface defining an interior compartment, wherein said wall further defines a cable passageway;
a second pulley remotely positioned from said first pulley;
an flexible cable having a first end and a second end disposed within said interior compartment, a first cable portion and a second cable portion extending from said first and second ends, respectively, through said cable passageway in opposing directions encompassing substantially entire circumference of said first pulley toward said second pulley, and an intermediate portion rotationally secured to said second pulley and joining said first and second portions, wherein the first portion is in tension upon rotation of the first pulley in a first direction and the second portion is in tension upon rotation of the second pulley in a second direction;
a cable tensioning assembly disposed in said interior compartment and engaged to said first and second ends of said cable, thereby pulling said first and second cable portions into said interior compartment.

19. The pull-pull cable assembly of claim 18, wherein said cable tensioning assembly includes a biasing member simultaneously urging said first and second ends across center of said first pulley, thereby pulling said first and second cable portions into said interior compartment.

20. The pull-pull cable assembly of claim 19, wherein said biasing member is a compression coiled spring pushing said first and second ends of said cable across center of pulley, thereby pulling said first and second cable portions into said interior compartment.
